(19) United States
(12) Patent Application Publication
(10) Pub. No.: US 2009/0063343 A1
(43) Pub. Date: Mar. 5, 2009

(54) METHOD AND SYSTEM TO PROVIDE CASHLESS REFUND

(75) Inventors: John K. Mertz, Los Gatos, CA (US); M. Brendan Philbin, Morgan Hill, CA (US)

Correspondence Address: SCHWEGMAN, LUNDBERG & WOESSNER, P.A., P.O. BOX 2938, MINNEAPOLIS, MN, 55402, US

(73) Assignee: Inmate Calling Solutions LLC d/b/a ICSolutions, San Jose, CA (US)

(21) Appl. No.: 12/199,591

(22) Filed: Aug. 27, 2008

Related U.S. Application Data
(60) Provisional application No. 60/968,643, filed on Aug. 29, 2007.

(51) Int. Cl. G06Q 40/00

(52) U.S. Cl. 705/41

(57) ABSTRACT

A computer-implemented system to provide a cashless refund, in one example embodiment, comprises a receiving module to receive a balance of a correctional facility account associated with a pre-released inmate information, a funds generator to generate a pre-released inmate payout amount based on the balance, a card dispenser to dispense a payout card in response to a pre-released inmate imminent release, the payout card including an encoded payout card number, a card activating module to activate the payout card by receiving the payout card into a payout card reader and associating a pre-released inmate information with the encoded payout card number, and a communication module to communicate to a card processor the pre-released inmate payout amount and that the payout card has been activated.

### RELATED APPLICATION

This application claims the priority benefit of U.S. Provisional Application Ser. No. 60/968,643 filed Aug. 29, 2007, the content of which is incorporated herein by reference in its entirety.

### TECHNICAL FIELD

This application relates to a method and system to provide a cashless refund.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

The release of inmates from a jail or prison is a very manpower-intensive effort. A commissary account is an account maintained for inmates to provide finds to spend at the prison store and to pay for other goods and services that may be available to the inmates. A commissary account may be funded by inmate's friends and family or by the inmates themselves using outside funds. When an inmate is released, whatever balance is left in the commissary account may be refunded to the inmate. The refund is usually made by cash or check. With both methods, there is a potential for fraud, coercion and other abuse by the officers of the correctional facility to extort money from the inmate.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing a network environment within which a method and system to provide a cashless refund may be implemented, in accordance with an example embodiment;

FIG. 2 is a block diagram illustrating a system to provide a cashless refund, in accordance with an example embodiment;

FIG. 3 is a flow chart illustrating an automated method to provide a cashless refund, in accordance with an example embodiment;

FIG. 4 is a block diagram illustrating an inmate record, in accordance with an example embodiment; and

FIG. 5 illustrates a diagrammatic representation of a machine in the example form of a computer system within which a set of instructions for causing the machine to perform any one or more of the methodologies discussed herein may be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The example embodiments described herein may be implemented in an operating environment comprising software installed on a computer, hardware, or a combination of software and hardware.

In an example embodiment, a method and system are described to provide a cashless refund. The method and system to provide a cashless refund may utilize an inactive payout card distributed to the inmate upon his/her release from the correctional facility automatically or by the personnel of the correctional facility. The method and system may be utilized to issue the balance of the commissary account, ether by cash or by check.

The system to provide a cashless refund, in one example embodiment, may be utilized to allow an inmate to come into a designated correctional facility area and enter his/her identification information into an information receiving module. The operators of the correctional facility may notify the cashless refund system about who is being released, their identifying information to ensure the security of the transaction, and a monetary amount that should be associated with the payout card.

In some example embodiments, a payout card would be distributed to correctional facility officials, who in turn, dispense the payout card to the inmate upon the inmate's release. Accordingly, the inmate receives the card from a releasing officer, and may, thereafter, call a specified telephone number to activate the card. The telephone call may be processed by the system to provide a cashless refund. The cashless refund processor has the release information including one or more of the following the inmate identification, the name, the address, the release code, and the monetary amount.

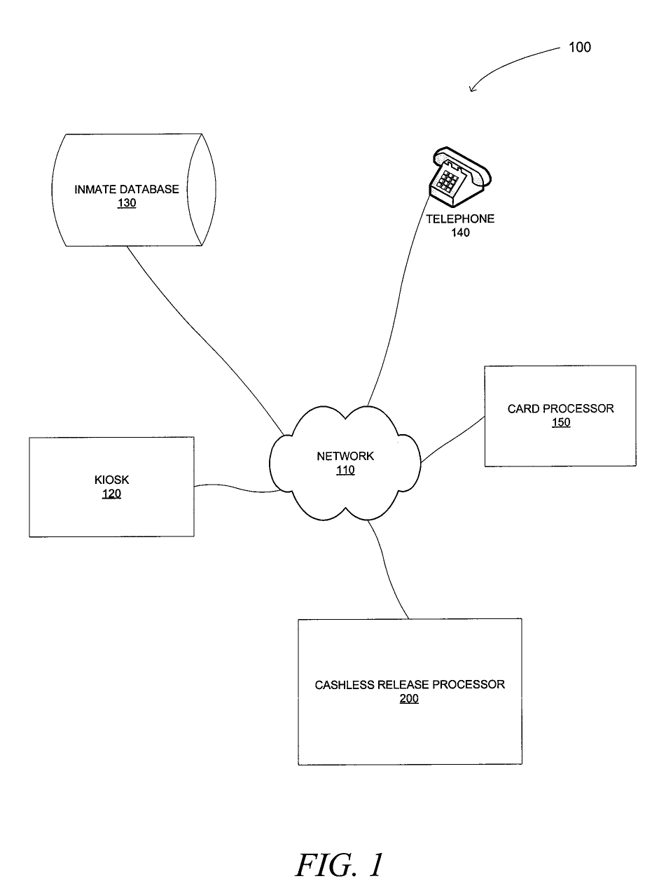

FIG. 1 shows a network environment 100, within which a method and system to provide a cashless refund may be implemented, in accordance with the example embodiment. As shown in FIG. 1, a sample network environment may comprise a kiosk 120, an inmate database 130, a telephone 140, a card processor 150, a jail management system (JMS), and a cashless release processor 200. In some example embodiments, the cashless release processor 200 may be located outside of the correctional facility, and, in some example embodiments, the cashless release processor 200 may include conventional telecommunication components. In some example embodiments, the kiosk 120 may be located within the correctional facility. A network environment 110 may be any communications environment facilitating Voice over Internet Protocol (VoIP) communications, a cellular communications network, Plain Old Telephone Service (POTS), or the like.

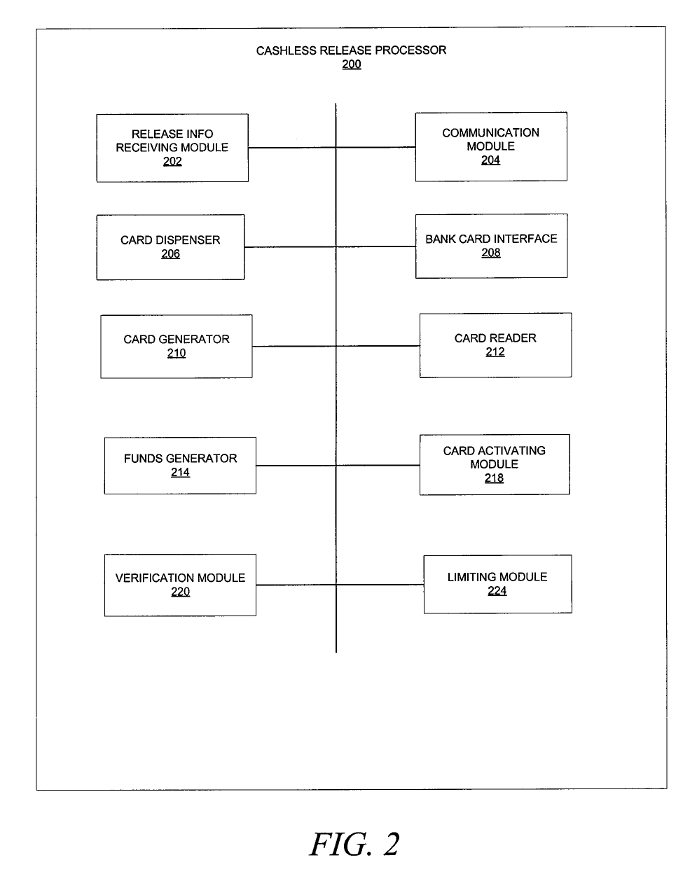

In an example embodiment, the kiosk 120 may be a special facility within a greater correctional facility used for the purpose of dispensing the payout card to the inmate upon the inmate's release. The cashless release processor 200 may be connected to the kiosk 120 through the network 110 and the telephone 140. The kiosk 120 may include an identification validation module, a card dispenser, and a card reader. In an example embodiment, the inmate database 130 may include an inmate record, an inmate identification, a release code, a date of release, an identification verification flag, a balance amount, a refund amount, a number of cards dispensed, an encoded payout card number, and a card processor transfer flag. The fields that are included in the inmate's record are explained in more detail below. In an example embodiment, the telephone 140 may be used to make a telephone call to the cashless release processor 200 or to the card processor 150 in order to activate the payout card. In an example embodiment, the card processor 150 may be an outside service provider receiving the payout card activation information and the amount due to the inmate from the cashless release processor 200 upon a successful activation of the payout card. In an example embodiment, cashless release processor 200 comprises various modules implementing cashless release of the inmate. A system to provide a cashless refund is described by way of example with reference to FIG. 2.

Referring to FIG. 2 of the drawings, the system to provide a cashless release processor 200 is shown to include several example components that may be configured to perform various operations. The system to provide a cashless release 200 may comprise a release information receiving module 202, a communication module 204, a card dispenser 206, a bank card interface 208, a card generator 210, a card reader 212, a funds generator 214, a card dispenser 206, a card activating module 218, a verification module 220, and a limiting module 224.

The release information receiving module 202, in an example embodiment, may be configured to receive information regarding the inmate to be released. Such information may include the inmate identification, the release code, the inmate date of release, and the balance due to the inmate from the commissary account upon the release. When the release information receiving module 202 receives the inmate release information, the information may be stored in the in the inmate database 130 to be later analyzed and communicated to the card processor 150 by the communication module 204.

The communication module 204, in an example embodiment, may be configured to receive telephone calls from the telephone 140 and to communicate the release information received by the release information receiving module 202 to the card processor 150. The inmate may call the cashless release processor 200 using the telephone 140 to activate the payout card. The communication module 204 may process the telephone call.

The card dispenser 206, in an example embodiment, is a card dispensing module that may be located inside the kiosk 120 and may be configured to dispense the prepaid card to the inmate upon successful verification of the inmate's identity by the identification verification module 220 and after the card generation by the card generator 210. The payout card dispensed by the card dispenser 206 may include an encoded payout card number that allows the card processor to associate the payout card with the account created for the inmate.

The bank card interface 208, in an example embodiment, is a user interface that may be configured to allow an inmate to enter his/her identifying information to be processed by the verification module 220. The bank card interface 208 may include a number pad configured to accept a personal identification number entered by hand or a voice recognition system and configured to accept the personal identification number by voice. The bank card interface 208 may include other functionality such as a menu of choices configured to accept confirmation of the selected menu choices.

The card generator 210, in an example embodiment, is a module that may be located inside the kiosk 120 and generate inactive payout cards to be later encoded with the payout card number and recognized by the card processor 150 as the payout card associated with the inmate. The inactive payout card generated by the card generator 210 may be later dispensed to the inmate by the card dispenser 206.

The card reader 212, in an example embodiment, is a module that may be located inside the kiosk 120 and configured to read the payout card generated by the card generator 210 and dispensed by the card dispenser 206. Upon reading the card by the card reader 212, the card activating module 218 may activate the card and communicate the activation information on to the communication module 204, which in turn communicates the information to the card processor 150.

The funds generator 214, in an example embodiment, may be configured to calculate the funds due to the inmate upon release by receiving an accounted balance of the inmate commissary account. The information created by the funds generator 214 is later communicated to the card processor 150 by the communication module 204.

The card activating module 218, in an example embodiment, is a module that may be located within the kiosk 120 and configured to activate the payout card dispensed by the card dispenser 206 by associating the encoded payout card number with the released inmate information. The amount due to the inmate and the activated payout card information is communicated to the card processor 150 by the communication module 204.

The verification module 220, in an example embodiment, is a module that may be located within the kiosk 120 and configured to verify the inmate identification information by comparing the information received by the release information receiving module 202 to the information entered by the inmate using the bank card interface 208. The information verified by the verification module 220 may comprise the inmate release code, the personal identification number, and a visual identification performed via a photograph or a video camera.

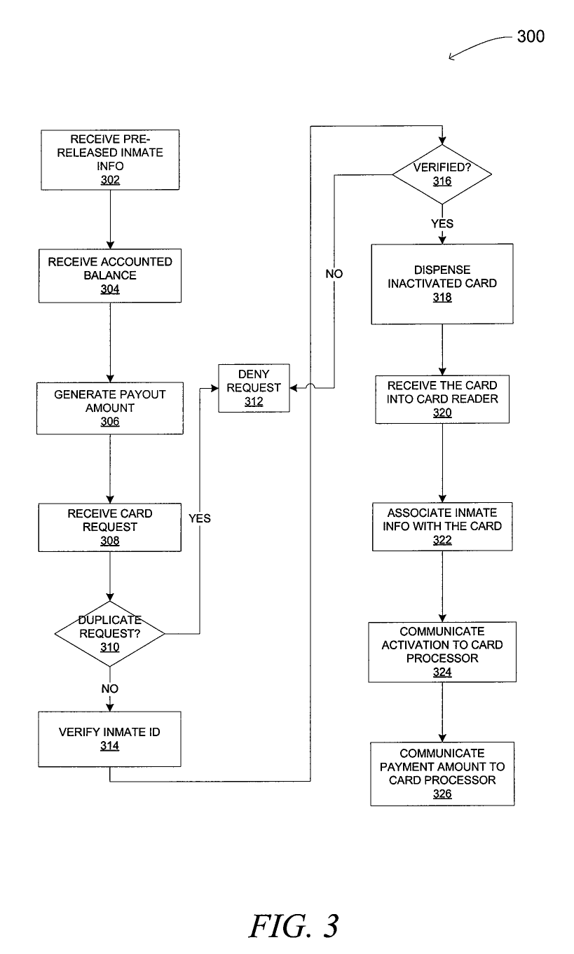

The limiting module 224, in some example embodiments, may be configured to determine the number of cards issued to the inmate and limit the number of cards to a pre-determined threshold. In some example embodiments, the number of the payout cards issued to the inmate is one and therefore the limiting module 224 may be configured to ensure that only one payout card is issued per inmate. Various operations performed by the system to provide a cashless release 200 are described by way of example with reference to an example method 300 of FIG. 3.

FIG. 3 is a flow chart illustrating a method 300 to provide a cashless refund, according to one example embodiment. The method may be performed by processing logic that may comprise hardware (e.g. dedicated logic, programmable logic, microcode, etc.), software (such as run on a general purpose computer system or a dedicated machine), or a combination of both. In one example embodiment, the processing logic resides at the system to provide a cashless release 200 illustrated in FIG. 2. The method 300 may be performed by the various modules discussed above with reference to FIG. 2. Each of these modules may comprise processing logic.

As shown in FIG. 3, the method 300 may commence, at the operation 302, with the release information receiving module 202 of the cashless release processor 200 receiving pre-release inmate information. The information received at operation 302 may indicate that the inmate is to be released and comprises the inmate identification, the inmate release code, the date of release, and the balance amount of the inmate commissary account. The information received at the operation 302 may be persisted to the database 130 in order to be later accessed by various modules of the cashless release processor 200 for the purpose of verification of the inmate identify, calculating the funds due to be distributed to the inmate, or to communicate the information to the card processor 150.

At the operation 304, the release information receiving module 202 of the cashless release processor 200 may receive an accounted balance of the inmate commissary account. The balance represents the difference between the funds deposited into the commissary account and the funds used by the inmate to buy goods and/or services while in the correctional facility. The accounted balance may be used by the funds generator 214 of the cashless release processor 200 to generate the payout amount due to be distributed to the inmate upon his/her release at the operation 306. The information received at the operations 302 and 306 may provide the cashless release processor 200 with a notification that that the inmate is due to be released and the amount left in his/her commissary account.

The information maybe provided through a network called the Jail Management System (JMS). The information received at the operations 302 and 304 may be characterized as a package that the correctional facility provides to the inmate upon his/her release, and the payout card later dispensed by the card dispenser 206 is a part of that package. The information received is stored in the inmate database 130 and awaits the next event, which may be a generation of the payout amount by the funds generator 214 occurring at the operation 306.

At the operation 306, the funds generator 214 of the cashless release processor 200 generates the payout amount from the balance of the accounted balance of the inmate's commissary account received at the operation 304. The payout amount generated at the operation 306 may not be the same as the balance of the commissary account due to other charges applied in the event of the inmate's release from the correctional facility. To generate the payout amount at operation 306, the funds generator 214 may access the information stored to the database 130 and deduct other charges or add overpayments. In some example embodiments, the funds are generated by the telephone call center agents that have access to the saved information.

At operation 308, the cashless release processor 200 may receive the payout card request. The request may be submitted by the inmate inside the kiosk 120 using the bank card interface 208. The inmate may enter the request by selecting a menu item of the bank card interface 208. In some example embodiments, the distribution of the payout card may be manually performed by the correctional facility personnel. Accordingly, the inmate may not use the bank card interface 208 to enter the request for the payout card. In such case, a request may be made to a telephone call center agent. At the decision block 308, the cashless release processor 200 may query the inmate database 130 to determine the number of payout cards dispensed to the inmate. If it is determined at the decision block 310 that the request to receive card is duplicate the request may be denied at operation 312. Whether or not the request is denied at the operation 312 may depend on how many payout cards are allowed per inmate in general or per this particular inmate as the number of the payout cards may be limited to a pre-determined number by the limiting module 224. Accordingly, if it at the decision block 310, it is determined that the request for the payout card received at the operation 308 is a duplicate request and the number of the payout cards issued per inmate is limited to one, the request may be denied at the operation 312.

If, on the contrary, it is determined at the decision block 310 that the request for a payout card made at the operation 308 is not a duplicate request or the request for a payout card made at operation 308 is a duplicate request but the total number of the payout cards has not reached the predetermined number of allowed payout cards, the request at the operation 308 will not be denied and the workflow will continue to the inmate identification verification at the operation 314.

At the operation 314, the verification module 220 of the cashless release processor 200 may verify the inmate identification. The verification may comprise visual identification and requesting the inmate to enter the release code and/or inmate's personal identification number. The information entered may be verified by the verification module 220 against the information in the inmate database 130. Other information verified against the inmate record of the inmate database 130 may include the inmate release date. Visual identification may also be a part of the process. As an example, the inmate may come into the kiosk 120 and enter his information through the bank card interface 208. Because the facility is aware of who is going to be released due to the information received by release information receiving module 202 at the operation 302 along with the inmate identification information, the personal identification code, and the dollar amount, the verification module 220 is able to perform the verification. In some example embodiments, the personnel of the correctional facility may take a photograph of the inmate requesting the transaction.

At the decision block 316, it is determined whether or not the inmate has been positively identified by the verification module 220. If it is determined at the decision block 316 that the inmate identification is positively verified then at the operation 318 the card dispenser 206 may dispense an inactive payout card to the inmate. If, on the contrary, it is determined at the decision block 316 that the inmate identification is not positively verified, the inmate's request for the payout card will be denied at the operation 312. If the request for the payout card is denied for the reasons of incorrectly entered release code and/or the inmate's personal identification code but not for the reason of incorrect release date and/or negative visual identification, the inmate may be given more attempts at entering the information via the bank card interface 208. The number of unsuccessful attempts may be limited by the limiting module 224.

At the operation 318, the payout card dispenser 206 may dispense the inactive card upon successful verification of the inmate's identity at the operation 316. Upon receiving the payout card at the operation 318, the inmate may proceed on to enter the inactive payout card into the card reader 212 at the operation 320 to activate the inactive payout card. It will be noted that in some example embodiments the inmate may place a telephone call to the card activating module 218 of the cashless release processor 200 to activate the inactive payout card. Such telephone call to the card activating module 218 of the cashless release processor 200 to activate the inactive payout card may be originated from outside of the correctional facility. If, however, the inmate uses the card reader 212 to activate the inactive payout card that may be located inside the kiosk 120, the request to activate the inactive payout card would be transmitted to the card activating module 218 of the cashless payout processor 200 electronically and the inmate release information may be associated with the payout card at the operation 322. As noted above, in some example embodiments, the inactive payout card is dispensed to the personnel of the correctional facility. Accordingly, the inmate would receive the inactive payout card from the releasing officer, and then call a telephone number which connects the inmate with the card activating module 218 which in some example embodiments comprises a telephone call center with an operator activating the inactive payout card. The operator would be able to look up the information in the inmate database 130 and activate the inactive payout card.

In some example embodiments, once the inactive card is received into the card reader 212 at the operation 320 and the inmate release information is associated with the payout card at the operation 322, the payout card may be encoded with the payout card number and the communication module 204 may communicate to the card processor 150 the inmate information and the encoded payout card number. The card processor 150 may be a third party card processor (e.g., First Data Resources) which would activate the payout card upon receiving the information from the communication module 204 at operation 324. In some example embodiments, at the operation 326, the communication module 204 may communicate a payment amount to the card processor 150 and the card processor 150 will associate the payment amount with the payout card. Such association will ensure that the inmate may charge the card up to the amount generated by the funds generator 214 as determined at the operation 306. Thus, the information that may be sent to the card processor 150 may comprise the information indicating that the payout card is now active and what is its monetary value. The information is sent out for activation to the card processor 150 such that any card that may be found inside the correctional facility is an inactive card.

In some example embodiments, the card may not be activated by inserting the inactive card into the card reader 212 at the operation 320 but instead it may be activated on the first use outside of the correctional facility. Thereafter, the inmate would be able to use the activated payout card as any other bank card at places that accept such cards to pay for goods and/or services. It will be noted that in some example embodiments the inactive payout card may be dispensed manually by the personnel of the correctional facility and may be activated by either using it outside the correctional facility or by calling the cashless release processor 200.

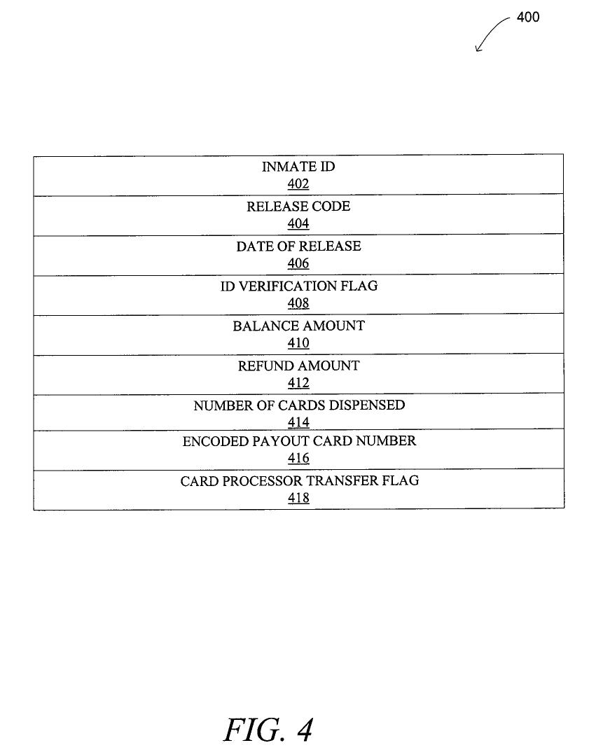

FIG. 4 illustrates by way of example a sample inmate record 400 of the inmate database 130. The sample inmate record 400 may, in some example embodiments, may include an inmate identification number 402, a release code 404, a date of release 406, an identification verification flag 408, a balance amount 410, a refund amount 412, a number of cards dispensed 414, an encoded payout card number 416, and a card processor transfer flag 418.

The inmate identification number 402 may be a record number assigned to every inmate of the correctional facility for the purposes of identification. The identification number may be received by the release information receiving module 202 at the operation 302. The release code 404 may be a code assigned to the inmate upon his/her imminent release from the correctional facility. The release code 404 may be a secret code only known by the authorized members of the correctional facility and/or the inmate. The release code 404 may be used for identification purposes at the operation 314 by the verification module 220. The date of release 406 is the date the inmate is supposed to be released. The date of release 406 may be part of the release package received by the release information receiving module 202 at the operation 302. The date of the release 406 may be verified by the verification module 220 at the operation 314 to ensure that the inmate's release date corresponds to the current date.

The identification verification flag 408 is a Boolean field and may be represented by true or false value. Thus if the inmate is successfully identified by the verification module 220 at the operation 314 of FIG. 3, the value of the identification verification flag 408 may be set to true (e.g. true or 1). The balance amount 410 may be part of the release package received by the release information receiving module 202 at the operation 302. The balance amount 410 represents the amount left in the inmate's commissary account upon his/her release from the correctional facility. The balance amount 410 may be used by the funds generator 214 to generate the payout amount at the operation 306. The refund amount 412 is the amount generated by the funds generator 214 in the operation 306 and represents the amount that is due to the inmate upon release. The refund amount 412 may be communicated to the card processor 150 as part of the payout card activation process in the operation 326. The refund amount 412 is the amount the inmate can spend using the payout card. The number of cards dispensed 414 is the number of cards dispensed per a particular inmate. In an example embodiment, there may be only one payout card dispensed per inmate. However, in some example embodiments, there may be more than one card dispensed per inmate. As discussed above, the limiting module 424 may be used to limit the number of the payout cards dispensed per inmate. Accordingly, the maximum value of the number of cards dispensed 414 may correspond to the predetermined number of the maximum payout cards dispensed per inmate.

The encoded payout number 416 is the number that may be magnetically encoded onto the payout card by the card activating module 218 at the operation 322. In some example embodiments, the encoded number maybe embossed or carved in the payout card. The encoded payout number 416 is communicated to the card processor 150 as part of the activation process. The card processor transfer flag 418 is a Boolean field and may be represented by true or false value. Thus if the payout card was successfully activated and the payout card information along with the inmate identification information and the refund amount is successfully communicated to the card processor 150 by the communication module 204 at the operation 324 and 326, the value of the transfer flag 418 may be set to true.

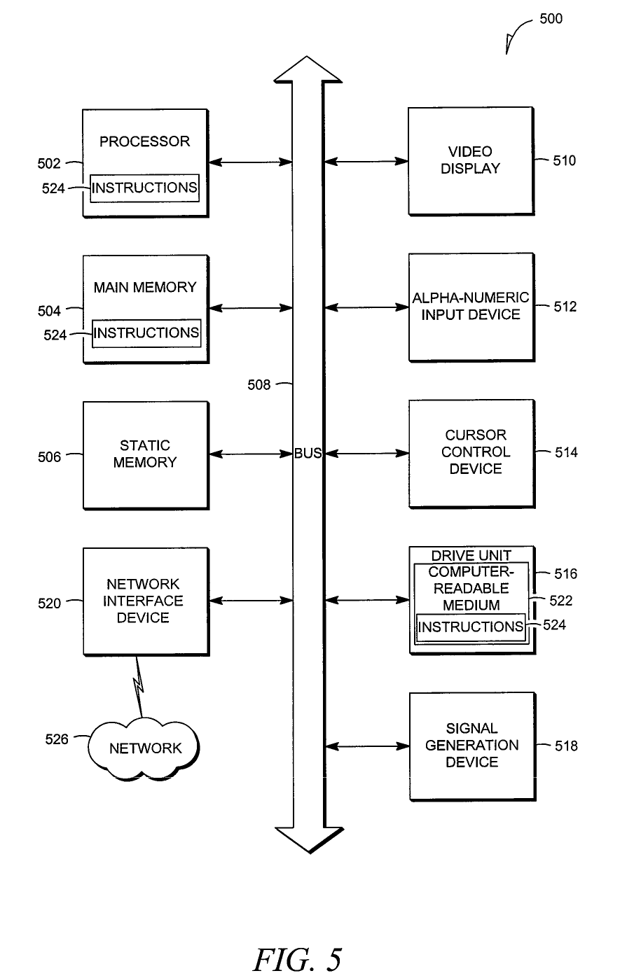

FIG. 5 illustrates an example computer system, according to one example embodiment. The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a user interface (UI) navigation device 514 (e.g., a mouse), a disk drive unit 516, a signal generation device 518 (e.g., a speaker) and a network interface device 520.

The disk drive unit 516 includes a computer-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 may further be transmitted or received over a network 526 via the network interface device 520 utilizing any one of a number of well-known transfer protocols (e.g., HTTP).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer, hardware, or a combination of software and hardware.

Thus, a method and system to provide a cashless refund have been described. Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A computer-implemented method comprising:
receiving a balance of a correctional facility account associated with a pre-released inmate information;
generating a pre-released inmate payout amount based on the balance;
dispensing an inactive payout card, the inactive payout card including an encoded inactive payout card number; and
associating the pre-released inmate information with the encoded inactive payout card number to activate the inactive payout card.

2. The computer-implemented method of claim 1, further comprising communicating to a card processor the pre-released inmate payout amount and that the inactive payout card has been activated.

3. The computer-implemented method of claim 1, wherein the activating of the inactive payout card is performed upon receiving the payout card into a payout card reader.

4. The computer-implemented method of claim 1, wherein the activating of the inactive payout card is in response to receiving a request via a telephone call.

5. The computer-implemented method of claim 1, further comprising verifying the pre-released inmate information in response to a request to dispense the inactive payout card.

6. The computer-implemented method of claim 1, wherein a request to activate the inactive payout card is received at a card reader, the card reader being provided at the correctional facility.

7. The computer-implemented method of claim 1, wherein the activating of the inactive payout card is in response to receiving a release code via a telephone call to a card processor.

8. The computer-implemented method of claim 1, wherein a number of the inactive payout card associated with the pre-released inmate information is limited to a pre-determined number.

9. The computer-implemented method of claim 1, wherein the dispensing of the inactive payout card is performed manually.

10. The computer-implemented method of claim 1, further comprising verifying a pre-released inmate identity prior to the dispensing of the inactive payout card.

11. A computer-implemented system comprising:
a receiving module to receive a balance of a correctional facility account associated with a pre-released inmate information;
a funds generator to generate a pre-released inmate payout amount based on the balance of the pre-released inmate correctional facility account;
a card dispenser to dispense a payout card in response to a pre-released inmate imminent release, the payout card including an encoded payout card number; and
a card activating module to activate the payout card by receiving the payout card into a payout card reader and associating the pre-released inmate information with the encoded payout card number.

12. The computer-implemented system of claim 11, further comprising a communication module to communicate to a card processor the pre-released inmate payout amount and that the payout card has been activated.

13. The computer-implemented system of claim 11, wherein the card activating module is to activate the payout card by receiving the payout card into the card activating module.

14. The computer-implemented system of claim 11, further comprising a verification module to verify the pre-released inmate information in response to a request to dispense the payout card.

15. The computer-implemented system of claim 11, wherein the card dispenser is to dispense the payout card at a correctional facility upon receiving a request to activate the payout card.

16. The computer-implemented system of claim 11, wherein the card activating module is to activate the payout card in response to receiving a request to activate via a telephone call.

17. The computer-implemented system of claim 11, further comprising a limiting module to limit a number of payout cards dispensed by the card dispenser to a pre-determined number of payout cards.

18. The computer-implemented system of claim 11, further comprising a verification module is to verify a pre-released inmate identity prior to the dispensing of the payout card.

19. A computer-readable medium comprising instructions, which when implemented by one or more processors perform the following operations:
receive a balance of a correctional facility account associated with a pre-released inmate information;
generate a pre-released inmate payout amount based on the balance;
dispense an inactive payout card, the inactive payout card including an encoded payout card number;
activate the inactive payout card and associate the pre-released inmate information with the encoded inactive payout card number; and
communicate to a card processor the pre-released inmate payout amount and that the inactive payout card has been activated.

20. A computer-implemented system comprising:
means for receiving a balance of a correctional facility account associated with a pre-released inmate information;
means for generating a pre-released inmate payout amount based on the balance;
means for dispensing an inactive payout card, the inactive payout card including an encoded payout card number;
means for activating the inactive payout card and associating the pre-released inmate information with the encoded inactive payout card number; and
means for communicating to a card processor the pre-released inmate payout amount and that the inactive payout card has been activated.
